(19) United States
(12) Patent Application Publication
(10) Pub. No.: US 2026/0093082 A1
(43) Pub. Date: Apr. 2, 2026

(54) SPLICE CASSETTE

(71) Applicant: CommScope Technologies LLC, Claremont, NC (US)

(72) Inventors: Chhunhour CHEA, Prior Lake, MN (US); Scott C. SIEVERS, Jordan, MN (US); Michael J. WENTWORTH, Belle Plaine, MN (US)

(73) Assignee: CommScope Technologies LLC, Claremont, NC (US)

(21) Appl. No.: 19/154,725

(22) PCT Filed: Feb. 8, 2024
(86) PCT No.: PCT/US2024/015053

§ 371 Date: Aug. 7, 2025

Related U.S. Application Data
(60) Provisional application No. 63/483,866, filed on Feb. 8, 2023.

(51) Int. Cl. G02B 6/44

(52) U.S. Cl. CPC G02B 6/4454; G02B 6/4457

(57) ABSTRACT

A cassette assembly designed to be mounted to a rail of a tray arrangement in telecommunications systems. The assembly can include a cassette base with a channel that extends along its length and is positioned between the first and second side. The channel can be sized to receive the rail of the tray arrangement and can defines a splice holder receiving channel that exposes the top surface of the rail. The spool can be selectively coupleable to the cassette base and can have fiber management members for routing fibers within the interior of the cassette base. The splice holder can be selectively coupleable to the spool and can be positioned within the splice holder receiving channel, with its bottom surface adjacent to and facing the top of the rail of the tray arrangement, enabling the splice holder to be positioned above the rail.

### CROSS-REFERENCE TO RELATED APPLICATION

This application is being filed on Feb. 8, 2024, as a PCT International Application and claims the benefit of U.S. Provisional Application No. 63/483,866 filed on Feb. 8, 2023, the disclosure of which is hereby incorporated by reference in its entirety.

### TECHNICAL FIELD

The present disclosure relates generally to cable management systems, more specifically, the present disclosure relates to a cassette assembly for organizing and protecting fiber optic cables or electrical wires within a tray arrangement.

### BACKGROUND

In the telecommunications industry, the demand for added capacity is growing rapidly. This demand is being met in part by the increasing use and density of fiber optic transmission equipment. Even though fiber optic equipment permits higher levels of transmission in the same or smaller footprint than traditional copper transmission equipment, the demand requires even higher levels of fiber density. This has led to the development of high-density fiber handling equipment.

In communications panel systems, port members (e.g., optical adapters, electrical jacks, hybrid port members, etc.) defining front ports are mounted to one or more trays that are disposable within a chassis. The front ports are configured to receive plug connectors at the fronts of the trays. The trays can either be stationary within a chassis or can slide forwardly of the chassis to enhance access to the port members. US Patent Publ. No. 2022/0260799 shows some example panel systems.

Improvements are desired.

### SUMMARY

One aspect of the present disclosure provides a cassette assembly designed to be mounted on a tray arrangement rail, including a cassette base with a channel in an intermediate portion of the base to receive the rail. In embodiments, the channel defines a splice holder receiving channel which exposes the top surface of the rail. The cassette assembly also includes a spool that can be attached to the base and with fiber management features. A splice holder can be attached to the spool and can be positioned in the splice holder receiving channel of the cassette base, so that the splice holder sits above the rail.

Another aspect of the present disclosure provides a cassette assembly designed to be mounted on a tray arrangement rail, including cassette base with a port member receiving aperture at the front, a cable entrance at the rear, and a region for a splice holder. The base can have one or more structures for routing fibers/cables from the front and rear to the splice holder region. The cassette assembly can also include a spool that can be attached to the cassette base and can include an S-shaped structure to route the fiber/cable from the front to the splice holder region to reduce crossing over the fiber/cable from the rear.

Yet another aspect of the present disclosure provides a method for routing a first fiber or cable and a second fiber cable within a cassette assembly.

In one embodiment, the cassette assembly is adapted to be mounted to a rail of a tray arrangement. The assembly includes a cassette base with a channel extending along its length, positioned between two sides of the cassette and sized to receive the rail. The channel defines a splice holder receiving channel that exposes the top surface of the rail to the interior of the cassette base. The assembly also includes a spool that can be coupled to the cassette base, and which has fiber management members to route fibers or cables within the interior. A splice holder can be coupled to the spool and positioned within the splice holder receiving channel of the cassette base, with its bottom surface facing the top of the rail.

In one embodiment, the cassette assembly has a cover that can be coupled to the cassette base to enclose its interior. The splice holder can be configured to hold a specific number of splices. The splice holder can be secured to the spool by a T-shaped aperture and a deflectable latch finger arrangement. The cassette base can have posts to secure the spool to it through an interference fit connection. The cassette base can also have port member receiving apertures at its front, with a specific number of them, and structure to route fibers or cables from the apertures to the splice holder.

In one embodiment, the cassette base defines an outer loop retention member and an inner loop retention member to route fibers or cables from the front apertures to the splice holder. The spool has an S-shaped structure to route fibers or cables from the front apertures to the splice holder to reduce crossing over a second fiber or cable from the rear cable entrance to the splice holder region. The cassette base also has a cable entrance at its rear and structure to route a second fiber or cable from the entrance to the splice holder region.

In one embodiment, the cassette assembly includes a cassette base and a spool. The cassette base is adapted to be mounted to a rail of a tray arrangement and has front and rear port member receiving apertures, a cable entrance, and a region to receive a splice holder. The cassette base has structure to route fibers or cables from the front and rear apertures to the splice holder region. The spool, which can be coupled to the cassette base, has an S-shaped structure to route fibers or cables from the front aperture to the splice holder region.

In one embodiment, a cassette assembly is provided, including a cassette base that is adapted to be mounted to a rail of a tray arrangement. The cassette base defines a port member receiving aperture at the front of the cassette base, a cable entrance at the rear of the cassette base, and a region configured to receive a splice holder. The cassette base also defines one or more first structures that enable routing of a first fiber or cable from the port member receiving aperture at the front of the cassette base to the region configured to receive a splice holder and one or more second structures that enable routing of a second fiber or cable from the cable entrance at the rear of the cassette base to the region configured to receive a splice holder, and a spool coupleable to the cassette base that defines an S-shaped structure configured to enable routing of the first fiber or cable from the port member receiving aperture at the front of the cassette base to the region configured to receive a splice holder.

In one embodiment, a method of routing a first fiber or cable and a second fiber or cable within a cassette assembly involves: cutting a distal portion of the first fiber or cable to a first predetermined length; cutting a proximal portion of the second fiber or cable to a second predetermined length; splicing the proximal portion of the first fiber or cable to the distal portion of the second fiber or cable with a splice; positioning the splice within a splice holder; routing the distal portion of the first fiber or cable from a port member receiving aperture at the front of a cassette base through one or more outer loop retention members to a cable entrance at the rear of the cassette base, aligning the distal portion of the first fiber or cable with the proximal portion of the second fiber or cable; positioning the splice holder within a spool; routing the proximal portion of the first fiber or cable through an S-shaped structure defined by the spool, aligning the proximal portion of the first fiber or cable with the distal portion of the second fiber or cable; routing the aligned intermediate portions of the first and second fiber or cable past one or more outer loop retention members and inner loop retention members; and positioning the spool within the cassette base.

### BRIEF DESCRIPTION OF THE DRAWINGS

The accompanying drawings, which are incorporated in and constitute a part of the description, illustrate several aspects of the present disclosure. A brief description of the drawings is as follows:

FIG. 1 is a perspective view depicting a communications panel mounted to a rack, in accordance with an embodiment of the disclosure.

FIG. 2 is a perspective view depicting a tray assembly including a plurality of rails, in accordance with an embodiment of the disclosure.

FIG. 3 is a close up, perspective view depicting a bay defined between two rails of a tray assembly, in accordance with an embodiment of the disclosure.

FIG. 4 is an end view depicting a bay defined between two rails of a tray assembly, in accordance with an embodiment of the disclosure.

FIG. 5 is a perspective view depicting a plurality of cassette assemblies of a first size attached to a tray assembly, in accordance with an embodiment of the disclosure.

FIG. 6 is a perspective view depicting a plurality of cassette assemblies of a second size attached to a tray assembly, in accordance with an embodiment of the disclosure.

FIG. 7 is a perspective view depicting a plurality of cassette assemblies of a third size attached to a tray assembly, in accordance with an embodiment of the disclosure.

FIG. 8 is a partially exploded, perspective view of a cassette assembly, in accordance with an embodiment of the disclosure.

FIG. 9 is an end view depicting a cassette assembly, in accordance with an embodiment of the disclosure.

FIG. 10 is a perspective view depicting a cassette base, in accordance with an embodiment of the disclosure.

FIG. 11 is a plan view depicting the cassette base of FIG. 10, in accordance with an embodiment of the disclosure.

FIG. 12 is a plan view depicting a spool, in accordance with an embodiment of the disclosure.

FIG. 13 is a perspective view depicting a six slotted splice holder, in accordance with an embodiment of the disclosure.

FIG. 14 is a perspective view depicting an eight slotted splice holder, in accordance with an embodiment of the disclosure.

FIG. 15 is a top perspective view of a four slotted splice holder, in accordance with an embodiment of the disclosure.

FIG. 16 is a bottom perspective view of the four slotted splice holder of FIG. 15, in accordance with an embodiment of the disclosure.

FIG. 17 is a plan view of an assembled cassette assembly, in accordance with an embodiment of the disclosure.

FIG. 18 is an end view depicting a splice holder positioned above or over a rail of a tray assembly within a cassette base, in accordance with an embodiment of the disclosure.

FIG. 19 is an end view depicting a splice holder positioned between two rails of a tray assembly within a cassette base, in accordance with an embodiment of the disclosure.

FIG. 20 is a partially exploded, plan view depicting a cassette assembly of a first size, in accordance with an embodiment of the disclosure.

FIG. 21 is a partially exploded, plan view depicting a cassette assembly of a second size, in accordance with an embodiment of the disclosure.

FIG. 22 is a partially exploded, plan view depicting a cassette assembly of a third size, in accordance with an embodiment of the disclosure.

FIG. 23 is a flowchart depicting a method of routing fibers within a cassette assembly, in accordance with an embodiment of the disclosure.

FIG. 24 is a schematic diagram depicting preferred fiber or cable lengths for use with a cassette assembly of a first size, in accordance with an embodiment of the disclosure.

FIG. 25 is a schematic diagram depicting preferred fiber or cable lengths for use with a cassette assembly of a second size, in accordance with an embodiment of the disclosure.

FIG. 26 is a schematic diagram depicting preferred fiber or cable lengths for use with a cassette assembly of a third size, in accordance with an embodiment of the disclosure.

FIG. 27 is a profile view of a cassette assembly in which one or more free ends of fibers or cables are positioned in proximity to one another in preparation for forming a splice therebetween, in accordance with an embodiment of the disclosure.

FIG. 28 is a profile view of a cassette assembly in which one or more free ends of fibers or cables are fused together in a splice assembly, in accordance with an embodiment of the disclosure.

FIG. 29 is a profile view of the cassette assembly in which the spliced ends of the fibers or cables are positioned within a splice holder, in accordance with an embodiment of the disclosure.

FIG. 30 is a schematic view depicting a general routing of fibers or cables to the splice holder, in accordance with an embodiment of the disclosure.

FIG. 31 is a profile view depicting a routing of fibers or cables around an S-shaped structure defined by a spool, in accordance with an embodiment of the disclosure.

FIG. 32 is a spool including S-shaped structure, in accordance with an embodiment of the disclosure.

FIG. 33 is a profile view depicting a routing of fibers or cables within a cassette assembly, in accordance with embodiment of the disclosure.

FIG. 34 is a profile view depicting a cassette assembly with fibers or cables routed therein, in accordance with an embodiment of the disclosure.

FIG. 35 is a profile view depicting a spool including one or more features for connection to a cassette base, in accordance with an embodiment of the disclosure.

FIG. 36 is a profile view depicting a cassette base including one or more features for connection to a spool, in accordance with an embodiment of the disclosure

FIG. 37 is a schematic view of a routing of fibers or cables within a cassette assembly, in accordance with an embodiment of the disclosure.

FIG. 38 is a profile depicting fibers or cables mounted within a cassette assembly of a first size, in accordance with an embodiment of the disclosure.

FIG. 39 is a profile depicting fibers or cables mounted within a cassette assembly of a second size, in accordance with an embodiment of the disclosure.

FIG. 40 is a profile depicting fibers or cables mounted within a cassette assembly of a third size, in accordance with an embodiment of the disclosure.

### DETAILED DESCRIPTION

Reference will now be made in detail to exemplary aspects of the present disclosure that are illustrated in the accompanying drawings. Wherever possible, the same reference numbers will be used throughout the drawings to refer to the same or like parts.

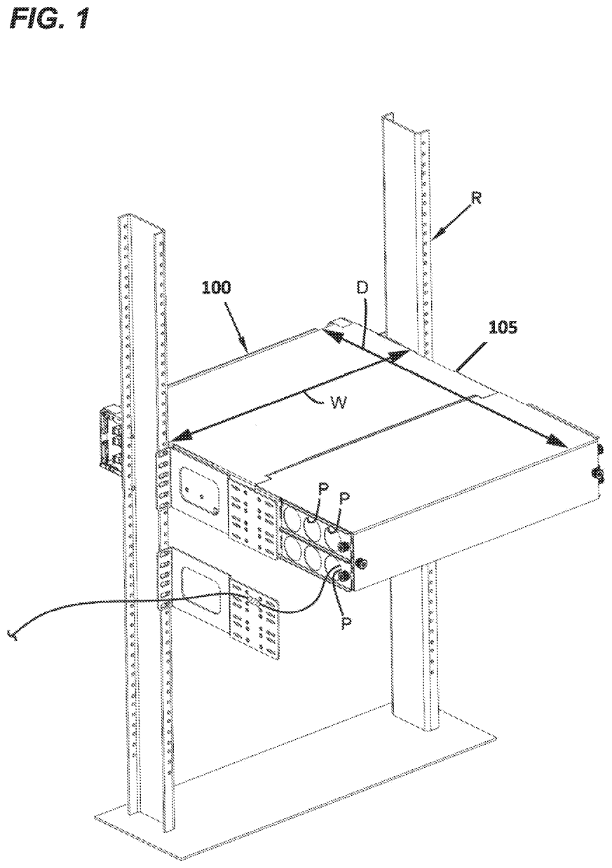

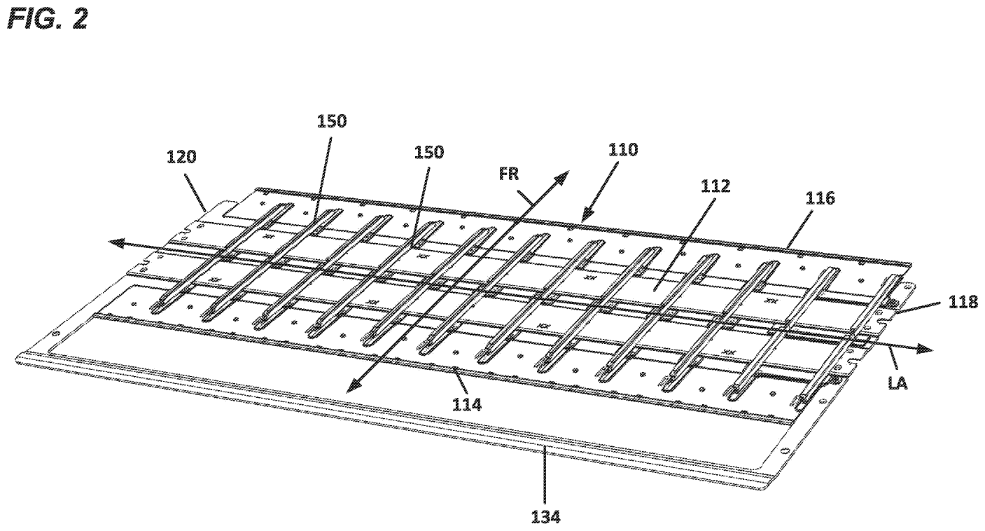

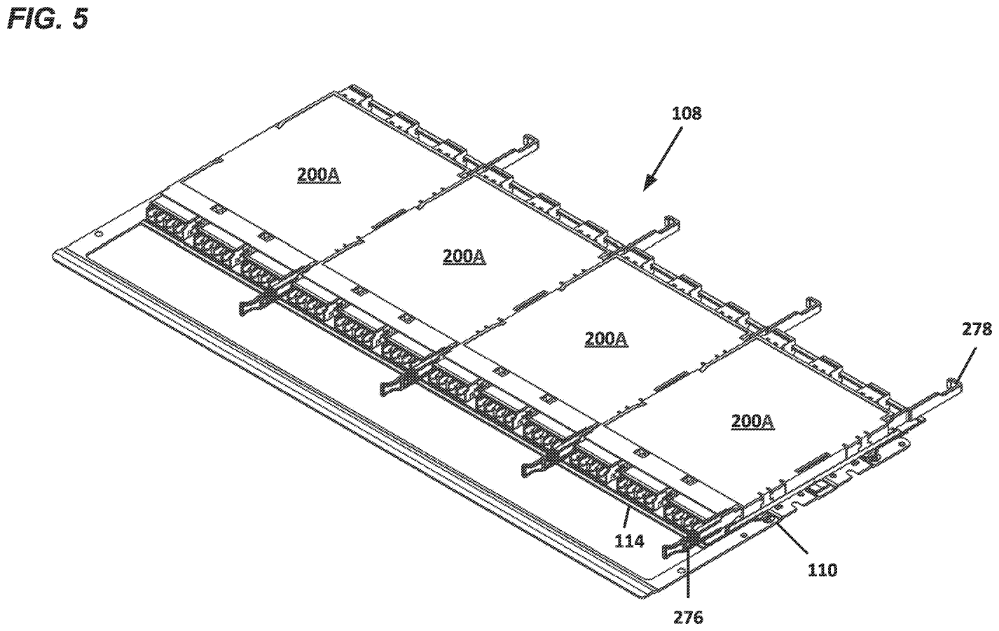

Referring to FIG. 1, a communications panel 100 mounted to a rack R, is depicted in accordance with an embodiment of the disclosure. In embodiments, the communications panel 100 can include a chassis 105 configured to hold one or more tray arrangements 110 (as depicted in FIGS. 2-4). For example, in some embodiments, the tray arrangements 110 can be slidably received along a depth (D) of the chassis 105. In other embodiments, the tray arrangements 110 can be fixed relative to the chassis 105. In some embodiments, each tray arrangement 110 can span a width (W) of the chassis 105. Each tray arrangement 110 can be configured to support one or more cassettes 200 (depicted in FIGS. 5-7) carrying ports (e.g., optical ports, electrical ports, hybrid ports, etc.) configured to receive plug connectors. A tray arrangement 110 populated with one or more cassettes 200 is referred to herein as a communications arrangement 108.

As best depicted in FIG. 2, the tray arrangement 110 can include a main region 112 that extends along a forward-rearward axis (FR) between a front end 114 and a rear end 116 of the main region 112. The main region 112 also extends along a lateral axis (LA) between opposite first and second sides 118, 120 of the main region 112. The main region 112 of the tray arrangement 110 can carry one or more rails 150. Each rail 150 can extend parallel to the forward-rearward axis (FR), and can be spaced apart from each other along the lateral axis (LA). The rails 150 can be configured to slidingly receive one or more cassettes 200 from either the front end 114 of the main region 112 or from the rear end 116 of the main region 112 at a discretion of a user.

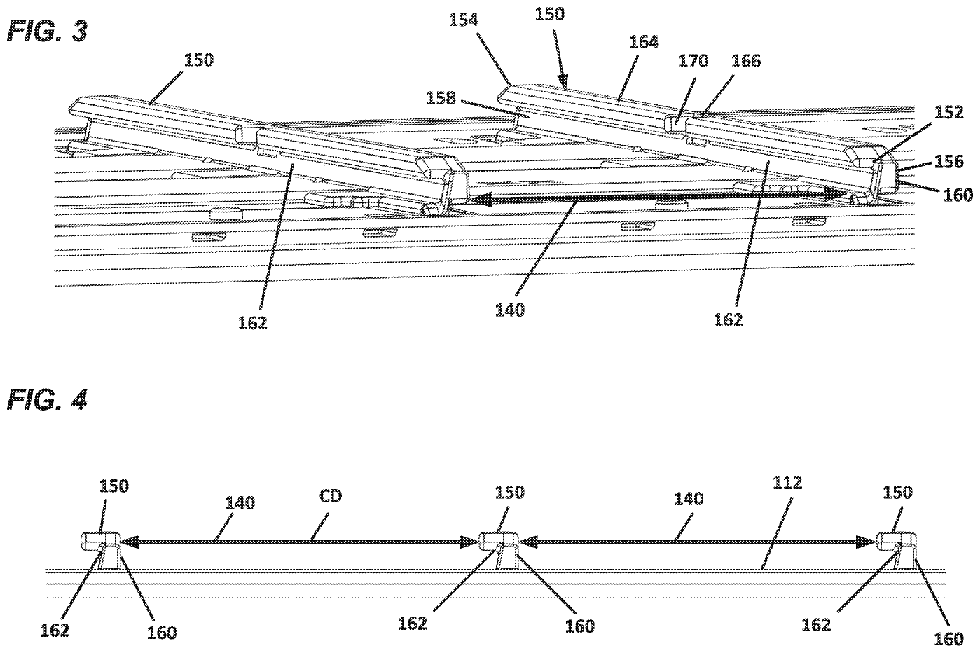

The rails 150 can extend across the main region 112 of the tray arrangement 110 along the lateral axis (LA). For example, as depicted in FIGS. 3-4, in some embodiments, the rails 150 are spaced a common distance (CD) apart from each other along the lateral axis (LA) to define one or more bays 140; although a bay 140 can also be bordered by only one rail 150, in which case the bay 140 extends toward the side wall of the chassis 105.

Each of the rails 150 can include a first side 156 and a second side 158, extending between a front end 152 and a rear end 154. In some embodiments, the rails 150 can be configured to engage (e.g., interconnect) with cassettes 200 from the second side 158. For example, as depicted, the first side 156 defines a closed surface 160 and the second side 158 defines a cassette engagement structure in the form of a groove 162 that extends along a length of the rail 150 between opposite ends. In some embodiments, the rail 150 can have a generally L-shaped or C-shaped cross-sectional profile along at least part of the length of the rail 150.

Further, each of the rails 150 can define a top surface 164 extending along the length of the rail 150. In certain examples, the top surface 164 of a rail 150 defines a ramped surface at the first and second sides of the groove 162. In some embodiments, top surface 164 can define a notch 166 at an intermediate position between the first and second sides of the groove 162, which can provide access to the groove 162 through the top surface 164. In certain implementations, the notch 166 provides access to a forward-facing catch surface and a rearward-facing catch surface at opposite ends of the notch 166.

As depicted in FIGS. 5-7, the cassettes 200A, 200B, 200C can be manufactured in a number of different base sizes. Each cassette base 202 can define a plurality of front apertures 212 (e.g., three front apertures, four front apertures, six front apertures, etc.) at the front end 204. Each of the front apertures 212 is configured to hold one or more front port members 230. For example, in one embodiment, the cassette base 202 can carry one or more a quadruplex LC adapters at each of the front apertures 212, which can define two duplex-LC ports (i.e., four LC ports). In other examples, the cassette base 202 can carry a duplex MPO adapter, two quadruplex SN adapters, two SC adapters, or any desired adapter type that fits in a quadruplex LC adapter footprint. In still other implementations, the front apertures 212 may be sized to handle other port footprints

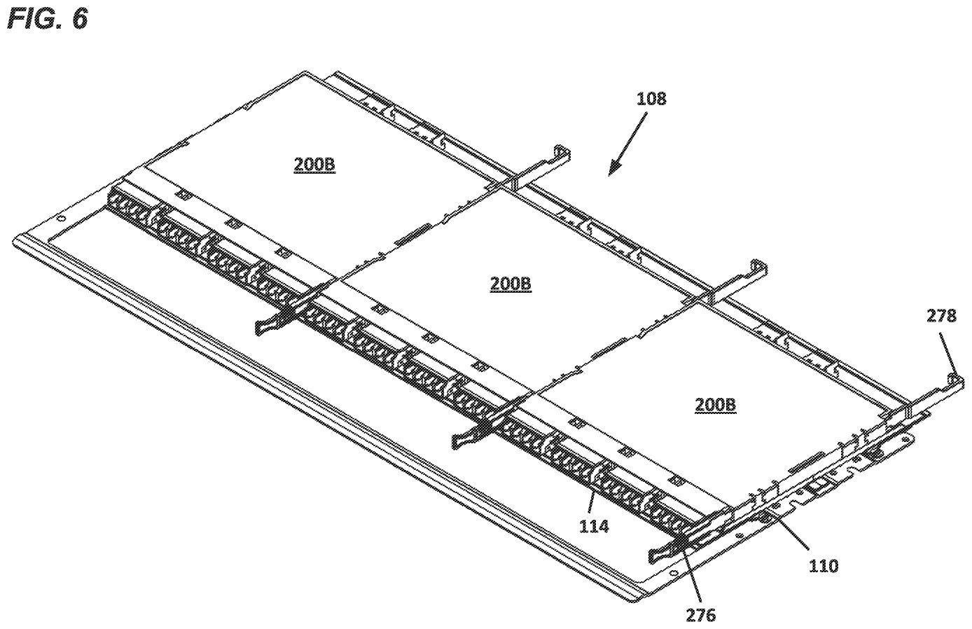

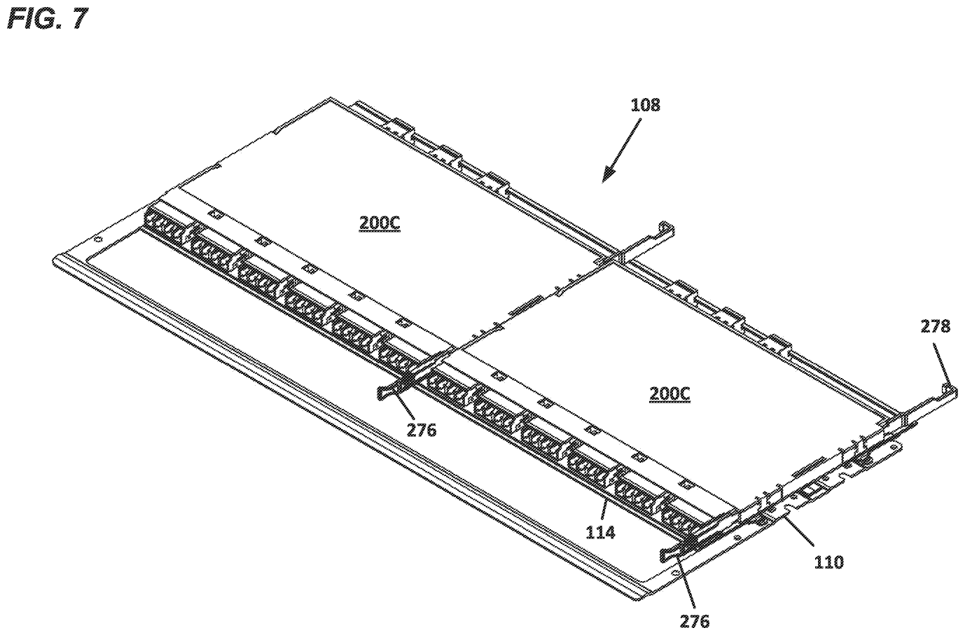

Various examples of different sizes of cassettes, include: a 6-duplex port/3-quadruplex port splice cassette 200A (as depicted in FIG. 5); an 8-duplex port/4-quadruplex port splice cassette 200B (as depicted in FIG. 6); and a 12-duplex port/6-quadruplex port splice cassette 200C (as depicted in FIG. 7). The cassettes 200 can have different widths, with larger base size cassettes typically being wider than smaller base size cassettes. In embodiments, the rails 150 and cassettes 200 are designed in a way that enables cassettes 200A, 200B, 200C of different sizes to fit on the same tray arrangement 110, without requiring the sizes of the cassettes to be in integer increments of each other. This allows the user the flexibility to load the tray arrangement 110 with a number of different sizes of cassettes, in some cases with multiple sizes of cassettes contained on a single tray arrangement 110.

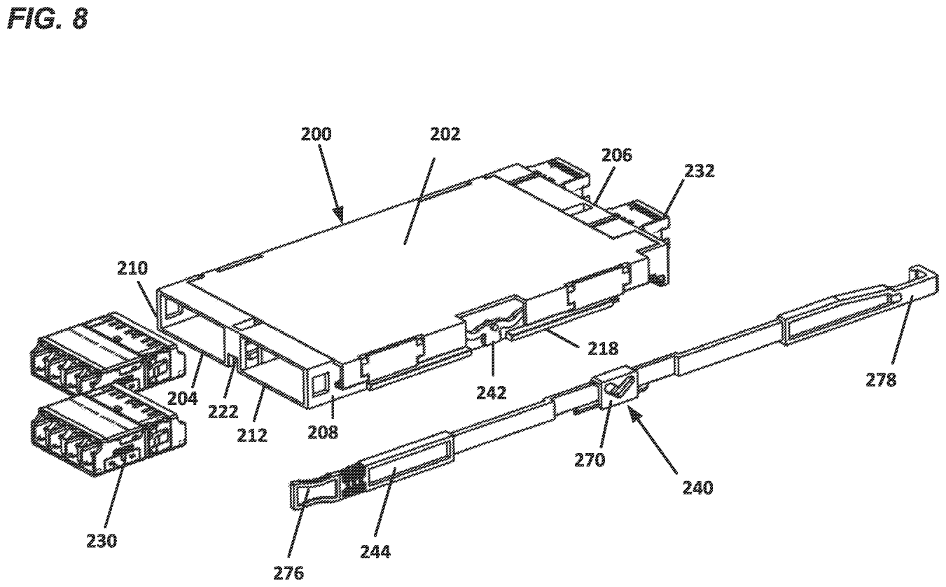

With additional reference to FIG. 8, each cassette can include a cassette base 202 that extends along a width between opposite first and second sides 208, 210, along a length between front and rear ends 204, 206, and along a height between a bottom and a top. The length, width, and height can be orthogonal to each other. In this particular embodiment, the cassette base 202 includes a pair of rear port members 232 (e.g., duplex MPO adapters) at the rear end 206 of the cassette base 202. In other embodiments, the cassette base 202 can define an opening through which an input cable can pass. The front port members 230 include an array of single-fiber optical adapters (e.g., a quadruplex LC adapter). In other embodiments, the front port members 230 can be configured to receive other types of adapters, including multi-fiber optical adapters (e.g., duplex MPO adapters, etc.). Fibers or cables, collectively referred to herein as “media segments”, can extend between the rear port members 232 (or the input cable rear passing through a rear of the cassette base 202) and the front port members 230 to form connections therebetween.

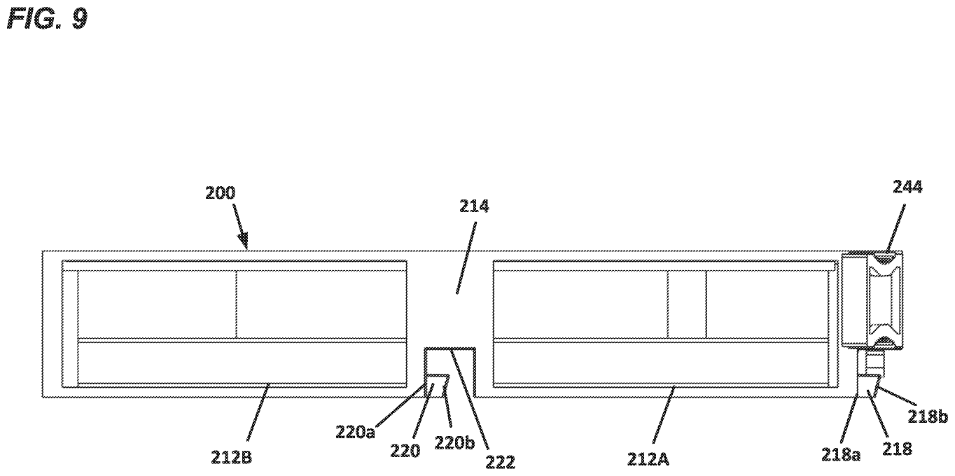

With additional reference to FIG. 9, the cassette base 202 can define one or more bottom channels 222 extending along the length of the cassette base 202. In embodiments, bottom channels 222 can be sized to receive rails 150, thereby enabling a cassette 200 to extend over one or more rails 150. In embodiments, each cassette 200 spans at least two bays 140 of the tray arrangement 110. For example, in some embodiments, the bottom channel 222 is disposed at an intermediate region 214 of the cassette 200 between two front apertures 212. In some implementations, the channels 222 can be sized so that a top of the channel 222 is spaced from the top surface 164 of the rail 150 received therein; alternatively, the channels 222 can be sized so that a top of the channel 222 rests on and slides along the top 164 of the rail 150.

In certain implementations, the cassette base 202 includes an end rail 218 at the first side 208 of the cassette base 202. The end rail 218 can be configured to fit within the groove 162 of a respective one of the rails 150, and can be configured to slide along the groove 162, from either the open front end or the open rear end of the groove 162. In some embodiments, the end rail 218 and the bottom rail 220 of each cassette base 202 extend in a common direction from a base end 218a, 220a attached to the cassette base 202 to a free end 218b, 220b. In an example, the common direction extends along the width of the cassette base 202. In some examples, the free ends 218b, 220b of the rails 218, 220 extend parallel with the height of the cassette base 202. In other examples, the free ends 218b, 220b of the rails 218, 220 are angled relative to the height of the cassette base 202.

In embodiments, the front and/or rear ends of the end rail 218 and the bottom rail 220 can be offset inwardly from the front 204 and rear 206 of the cassette base 202. For example, the front and rear of the bottom rail 220 can be disposed within a respective bottom channel 222. Offsetting the front and/or rear ends of the rails 218, 220 may facilitate positioning of the cassette 200 on the tray arrangement 110 by first roughly aligning the rails 150 with the bottom channel 222 and then aligning the rails 118 with the grooves 162 of the rails 150.

In certain implementations, the cassettes 200 are configured to lock to the rails 150 in at least one discrete position. For example, with continued reference to FIG. 8, each cassette 200 can include a latching arrangement 240 that rides over the top 164 of a respective one of the rails 150. The latching arrangement 240 can include a stop member 242 that drops into the notch 166 of the respective rail 150to lock the cassette 200 relative to the rail 150. The latching arrangement 240 can also include a release handle 244 to raise the stop member 242 out of the notch 166.

For example, in some embodiments, the stop member 242 can be carried by the cassette base 202 at the first side 208, and can be movable relative to the cassette base 202 along a movement axis that extends parallel to the height of the cassette 200. In some embodiments, the stop member 242 is movable along the movement axis between a lock position and a release position, with the stop member 242 biased to the lock position.

In operation, the stop member 242 can ride over the ramped surface 172 at the front end 152 or rear end 154 of the rail 150 when the cassette 200 is first mounted to the rails 150. The ramped surfaces 172 can transition the stop member 242 from the lock position to the release position, such that the top 164 of the rail 150 maintains the stop member 242 in the release position until the stop member 242 vertically aligns with the notch 166. The notch 166 allows the stop member 242 to transition to the lock position. Further details regarding the latching and unlatching of the cassette 200 relative to the tray arrangement 110 is disclosed in US Patent Publ. No. 2022/0260799, the contents of which are incorporated by reference herein in their entirety.

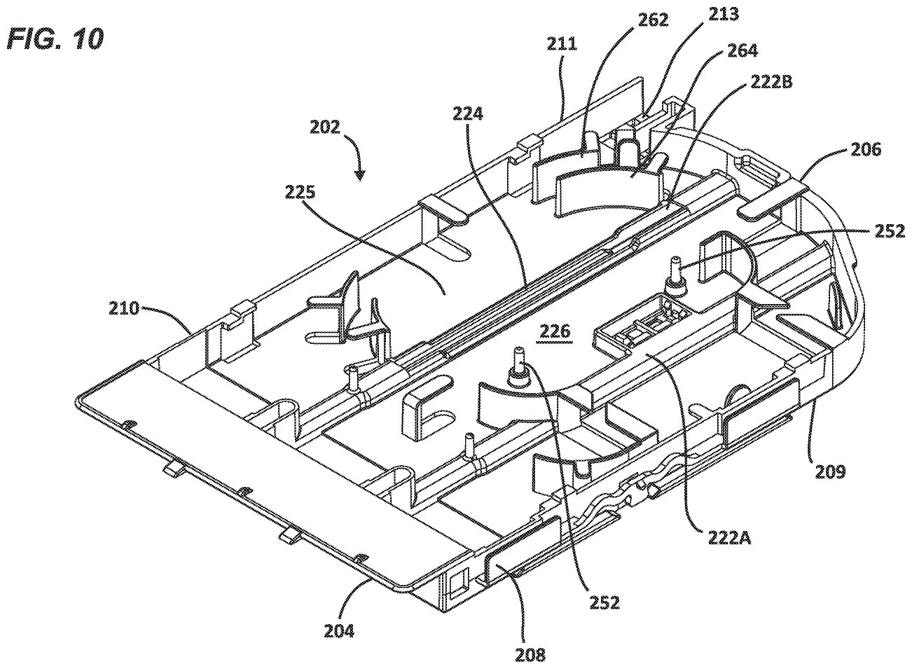

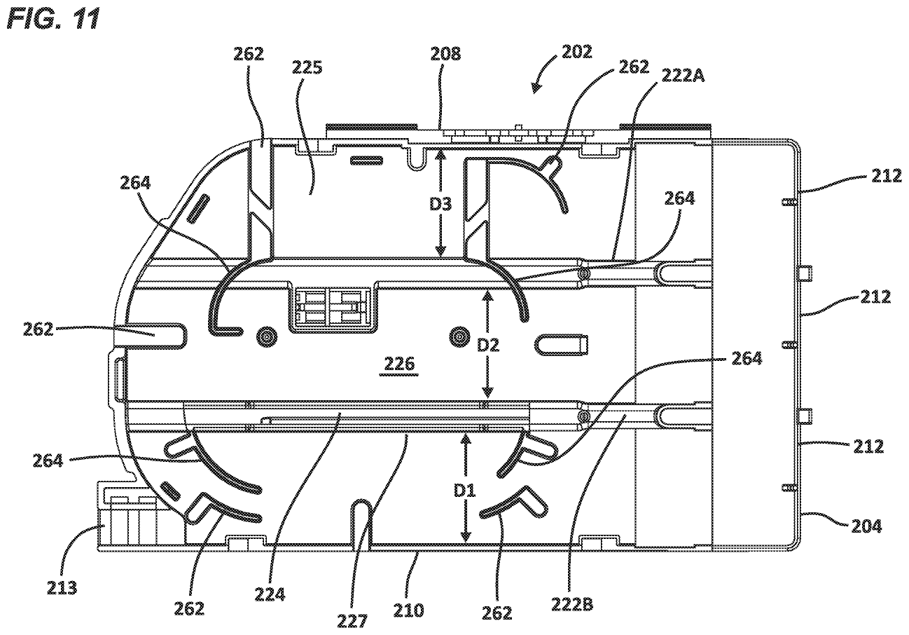

Referring to FIGS. 10-11, a cassette base 202 is depicted in accordance with an embodiment of the disclosure. The cassette base 202 can extends along a width between a first side 208 and a second and 210, along a length between a front end 204 and a rear end 206, and along a height between a bottom 209 and a top 211. In some embodiments, the length, width, and height can be orthogonal to each other. In embodiments, the cassette base 202 can define a channel 222 extending at least partially along the length of the cassette base 202. In some embodiments, the channel 222 can be positioned at an intermediate width between the first side 208 and the second side 210. For example, in some embodiments, the cassette base 202 can define a pair of channels 222A, 222B, with a substantially equal distances (D1, D2, D3) positioned between each of the first side 208, a first channel 222A, a second channel 222B, and the second side 210.

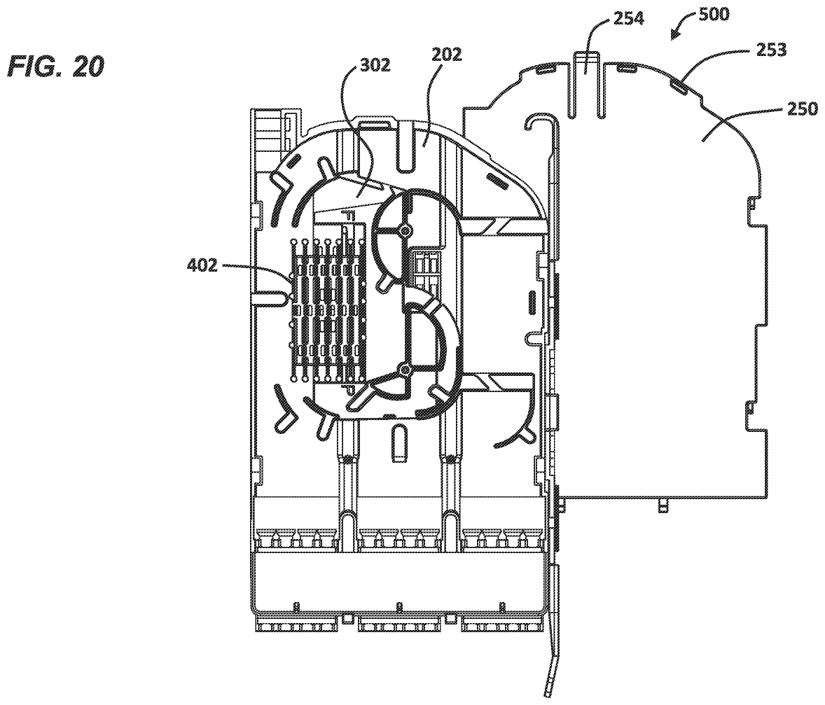

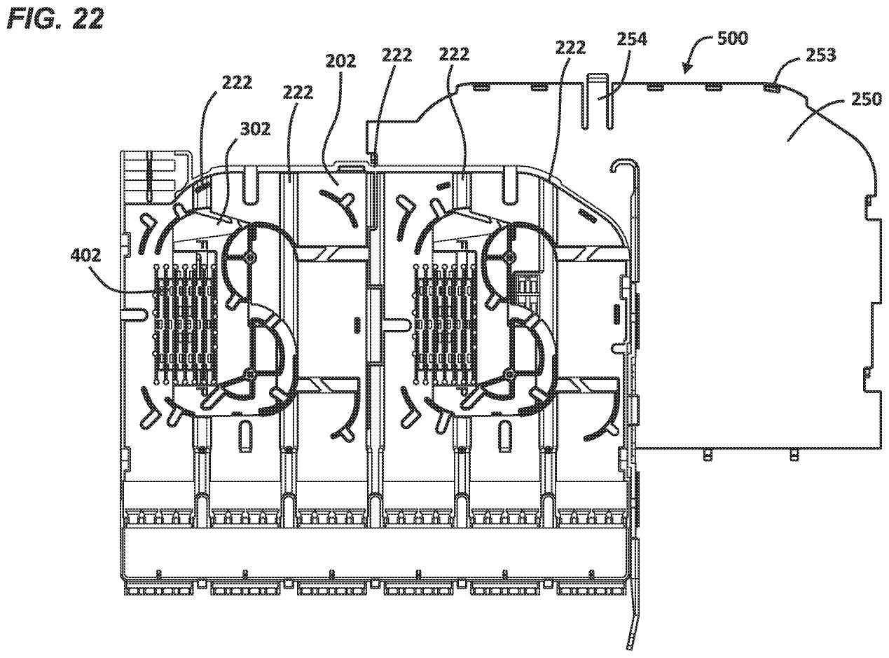

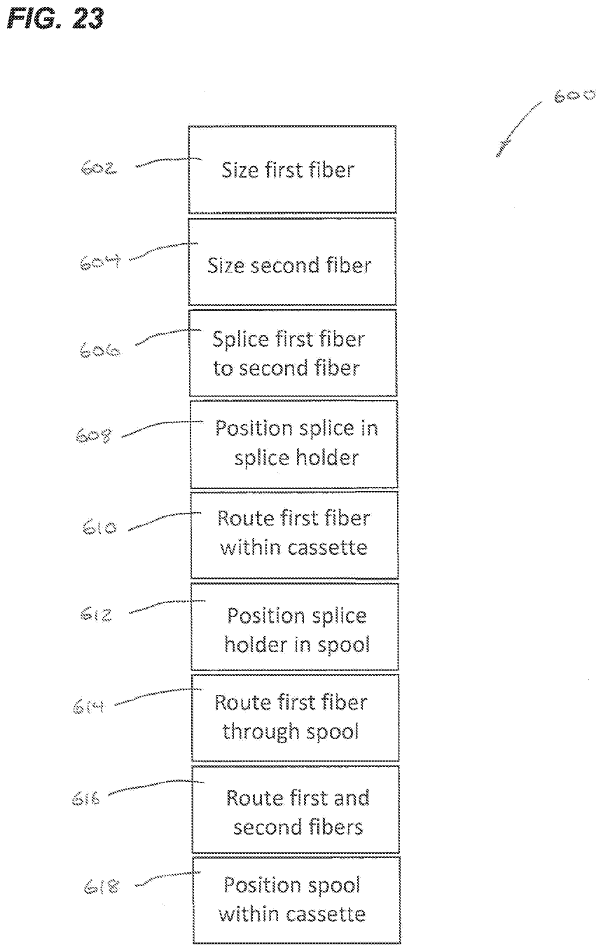

In other embodiments, the distances can be staggered, provided that at least one channel 222 is positioned at least part way between the first side 208 and the second side 210. As further depicted in FIGS. 20-23 the use of more than two channels 222 is also contemplated. For example, in some embodiments, the cassette base 202 can define three-spaced apart channels 222 (as depicted in FIG. 22), or six-spaced apart channels 222 (as depicted in FIG. 23). In embodiments, each of the channels 222 can be shaped and sized to receive a rail 150 of the tray arrangement 110, thereby enabling the cassette base 222 to at least extend over one rail 150 of the tray arrangement 110.

As further depicted in FIGS. 10-11, in some embodiments, the channel 222 can define a splice holder receiving channel 224. For example, in some embodiments, the splice holder receiving channel 224 can be defined by removal of a portion of the structure defining the channel 222, thereby exposing a top surface 164 of the rail 150 of the tray arrangement 100 to an interior 226 of the cassette base 202, when the cassette base 202 is operably coupled to the tray arrangement 100.

In some embodiments, the bottom of the cassette base 202 can be defined by a floor 225, which can be substantially planar between channels 222, and arranged as a longitudinally oriented raised portion traversing over the channel 222. In some embodiments, the splice holder receiving channel 224 can be defined by removal of a portion of the floor 225, thereby exposing portions of the interior 226 of the cassette base 222 to portions of the tray arrangement 110, when the cassette base 202 is operably coupled to the tray arrangement 100.

In embodiments, the cassette base 202 can define one or more port member receiving apertures 212 in the front and 204 of the cassette base 202. For example, in the various depicted embodiments, the cassette base 202 can define at least three-port member receiving apertures 212, four-port member receiving apertures 212, or six-port member receiving apertures 212; although other numbers of port member receiving apertures are also contemplated. In some embodiments, the cassette base 202 defines a cable entrance 213 at a rear end 206 of the cassette base 202 shaped in size to enable a bundle of fibers or cables to pass therethrough. In some embodiments, the cable entrance 213 can define apertures or structures at which one or more cable ties (e.g., zip ties, hook-and-loop straps, etc.) can be mounted to secure one or more fibers or cables passing therethrough. To facilitate coupling and uncoupling of components to the cassette base 202, in some embodiments, the cassette base 202 can define one or more posts 252 configured to be received in one or more receptacles of components selectively attachable or connectable to the cassette base 202 (e.g., spools, splice trays, etc.).

In some embodiments, the cassette base 202 can define structure configured to enable routing of a first fiber or cable from one or more port receiving apertures 212 at the front end 204 of the cassette base 202 to a region 227 of the cassette base 202 configured to receive a splice holder (e.g., in the vicinity of the splice holder receiving channel 224). For example, in one embodiment, the cassette base 202 can define at least one outer loop retention member 262 configured to receive a first, outer loop of a first fiber or cable routed from the port receiving aperture 212 towards a rear end 206 of the cassette base 202. In some embodiments, the at least one outer loop retention member 262 can include a partial wall defining a predetermined or minimum bend radius, and one or more cable retention tabs extending generally parallel to the floor 225 configured to retain the first fiber or cable in position relative to the outer loop retention member 262. In some embodiments, a plurality of outer loop retention members 262 can be provided around a perimeter of the region 227, thereby defining a preferred route the positioning and retention of fibers or cables within the interior 226 of the cassette base 202.

In some embodiments, the cassette base 202 can define at least one inner loop retention member 264 configured to receive a second, inner loop of the first fiber or cable as the first fiber or cable traverses from the port receiving aperture 212 to region 227. In some embodiments, the at least one inner loop retention member 264 can include a partial wall defining a predetermined or minimum bend radius, and one or more cable retention tabs extending generally parallel to the floor 225 configured to retain the first fiber or cable in position relative to the inner loop retention member 264.

In some embodiments, a plurality of inner loop retention members 264 can be provided to define a preferred route the positioning and retention of fibers or cables within the interior 226 of the cassette base 202. In embodiments, the inner loop retention members 264 can be positioned to form a loop closer to the region 227 than a loop formed by the outer loop retention members 226. In some embodiments the structure configured to enable routing of the first fiber or cable (e.g., the inner and outer loop retention members 262, 264, etc.) can also be used for the routing and retention of a second fiber or cable traversing from the cable entrance 213 at a rear end 206 of the cassette base 202 to the region 227 of the cassette base 202 configured to receive a splice holder, thereby enabling an efficient routing of cables within the interior 226. Moreover, in embodiments, the various structures as described herein can enable routing of cables or fibers within the interior 226 without crossing the first fiber or cable with the second fiber or cable, which can present a significant space savings, particularly where the fibers or cables are ribbonized.

With additional reference to FIG. 12, a spool 302 is depicted in accordance with an embodiment of the disclosure. In embodiments, the spool 302 can be selectively coupleable to the cassette base 202. For example, in some embodiments, the spool 302 can define one or more receptacles 304 configured to receive one or more posts 252 defined by the cassette base 202, thereby enabling an interference fit connection between the one or more receptacles 304 and the one or more posts 252.

In embodiments, the spool 302 can define one or more fiber management members to facilitate routing of fibers or cables within the interior 226 of the cassette base 202. For example, in one embodiment, the spool 302 can define an S-shaped structure 306 configured to enable routing of a first fiber or cable from one of a plurality of port member receiving apertures 212 at a front end 204 of the cassette base 202 to a region 227 of the cassette base 202 configured to receive a splice holder, while minimizing occurrences of crossing over a second fiber or cable traversing from the cable entrance 213 at the rear end 206 of the cassette base 202 to the region 227. In some embodiments, the S-shaped structure 306 can be configured to route at least one of the first or second fiber or cable around opposite sides of a pair of receptacles 304. In some embodiments, the S-shaped structure 306 can define at least one wall 308 extending orthogonally upwardly from a floor 310, which can be shaped to define a preferred routing path or minimum bend radius of the fiber or cable. In some embodiments, the S-shaped structure 306 can define one or more tabs extending outwardly from the wall 308 substantially parallel to the floor 310, and configured to generally retain the fiber or cable in position relative to the S-shaped structure 306.

In some embodiments, the spool 302 can further define one or more indicators or markings 314, which can be used as a guide and proper orientation of the spool 302 relative to the cassette base 202, during assembly of a cassette assembly. To facilitate the coupling of a splice tray to the spool 302, in some embodiments, the spool 302 can define at least one of a T-shaped aperture 316, and a deflectable latch finger arrangement 318 configured to interface with corresponding portions defined by the splice tray. To enable the cassette base 202 to be constructed with a minimum clearance (e.g., height), in some embodiments, a portion of the floor 310 in proximity to the splice holder receiving channel 224 can be removed, such that in some embodiments, a top of the floor 310 can be substantially flush with a top 162 of a rail 150 positioned within the channel 222, when the cassette base 222 is operably coupled to the tray arrangement 110.

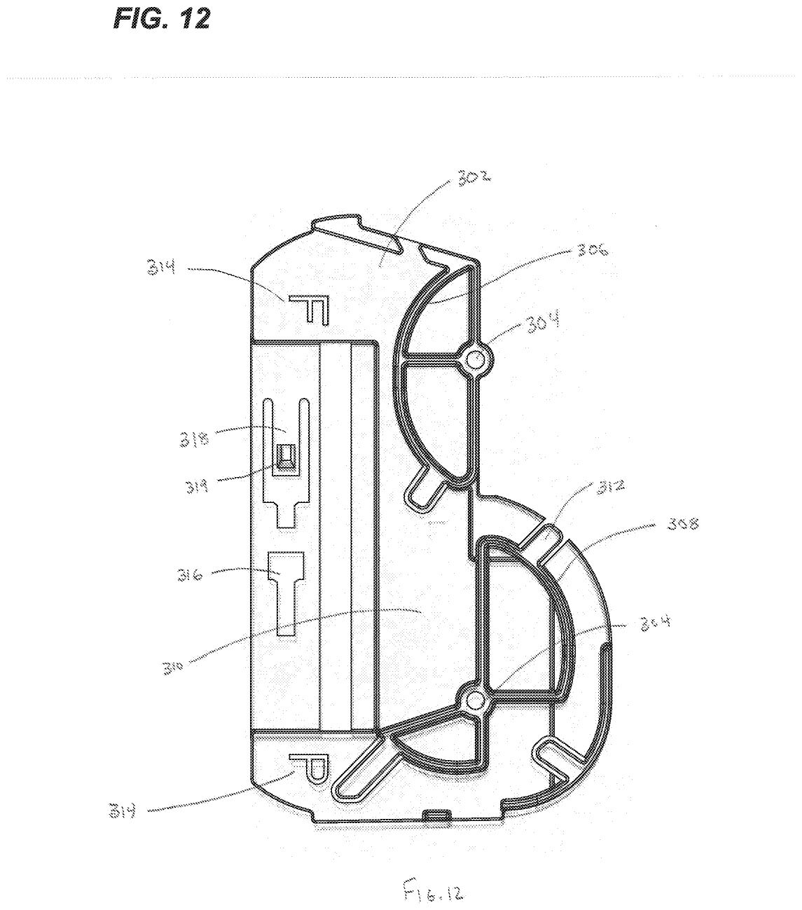

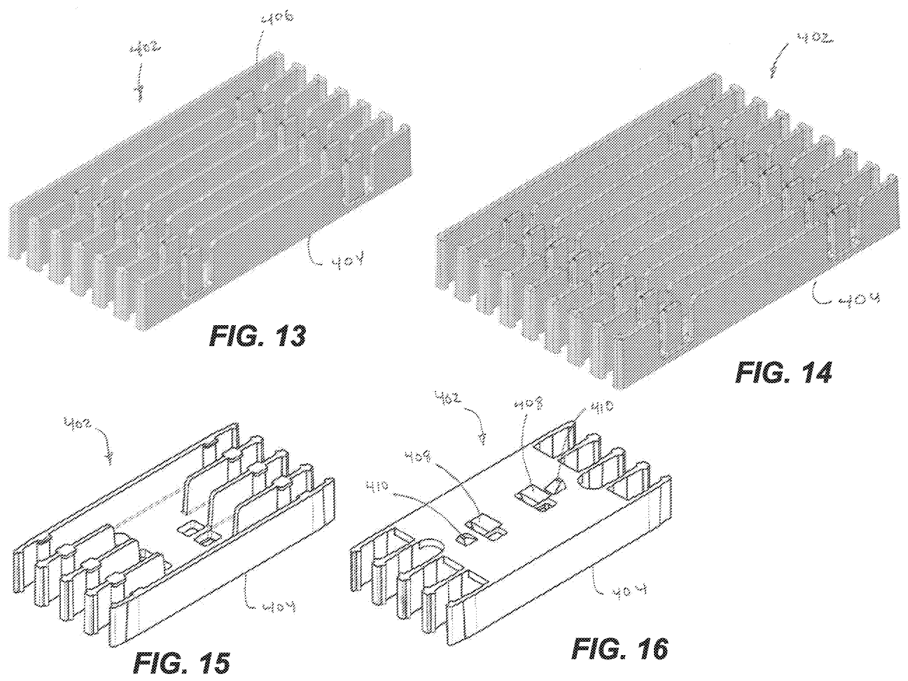

Referring to FIGS. 13-16, various embodiments of splice holders 402 are depicted in accordance with embodiments of the disclosure. In embodiments, the splice holder 402 can be selectively coupleable to the spool 302 (e.g., via one or more T-shaped apertures 316, latch finger arrangement 318, and/or dovetail arrangements 408, etc.), thereby enabling the splice holder 402 to be operably coupled to the cassette base 202. Further details regarding interconnection between a splice holder 402 and a spool 302 are disclosed in U.S. Pat. No. 11,402,589, the contents of which are incorporated by reference herein in their entirety.

As depicted, the example splice holders depicted in FIGS. 13 & 14 can be capable of securing two rows of single fusion splices. For example. the splice holder of FIG. 13 can secure up to twelve single fusion splices. The splice holder of FIG. 14 secure up to sixteen single fusion splices. The splice holder of FIGS. 15-16 secures one row of mass fusion splice protectors, and can hold up to four splices. In yet other embodiment, the splice holder can include six slots to secures one row of mass fusion splice protectors, and can hold up to six splices. The depicted splices are exemplary and should not be considered limiting; other splice holder configurations are also contemplated.

In embodiments, spool 302 can be positioned within the cassette base 202, such that the splice holder 402 is positioned in the splice holder receiving channel 224. In some embodiments, a bottom surface 404 of the splice holder 402 can be positioned to and face a top surface 164 of a rail 150, when the cassette base 222 is operably coupled to the tray arrangement 110, thereby enabling the splice holder 402 to be positioned above a rail 150 of the tray arrangement 110.

In embodiments, the splice holder 402 can be configured to hold multiple single fiber splice protectors (e.g., splices between two single fibers, etc.). In other embodiments, the splice holder 402 can be configured to hold multiple multi-fiber splice protectors (e.g., mass fusion splices). In embodiments, the splice holder 402 can define one or more channels configured to receive splice protectors. For example, as depicted, in some embodiments, the splice holder 402 can define at least four channels, six channels or eight channels configured to receive and retain splice protectors; although other numbers of channels are also contemplated.

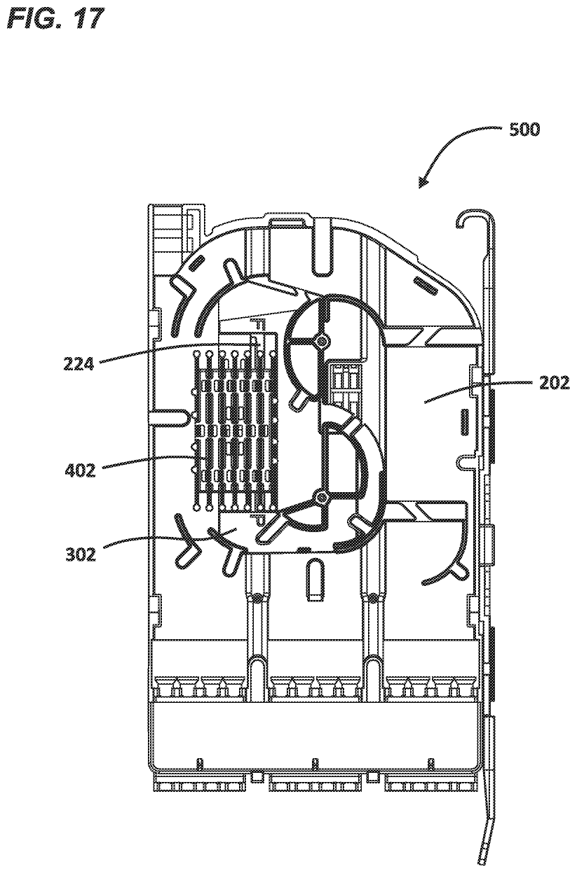

Referring to FIG. 17, a cassette assembly 500, adapted to be mounted to a rail 150 of a tray arrangement 110 is depicted in accordance with an embodiment of the disclosure. In some embodiments, the cassette assembly 500 can include a cassette base 202, a cover 250, at least one spool 302, and at least one splice holder 402. In some embodiments, the splice holder 402 can be operably coupled to the spool 302, and the spool can be operably coupled to the cassette base 202, such that the splice holder 402 is nested within a splice holder receiving channel 224 defined by a portion of the cassette base 202. In some embodiments, a bottom surface of the splice holder 402 is positioned adjacent to and faces a top surface 164 of a rail 150, when the cassette base 222 is operably coupled to the tray arrangement 110.

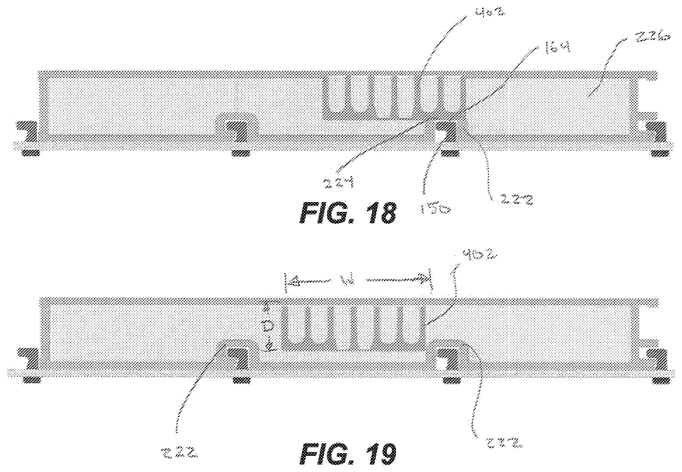

As further depicted in FIGS. 18-19, positioning the splice holder 402 above the rail 150 provides greater flexibility in positioning of the splice holder 402 within the interior 226 of the cassette base 202. In particular, with the splice holder 402 having a fixed depth (D), absence the presence of a splice holder receiving channel 224, positioning the splice holder 402 within the interior 226 of the cassette base 202 would be limited to the area located between channels 222. Embodiments of the present disclosure, which include at least one splice holder receiving channel 224 enable positioning of the splice holder 402 directly above a rail 150, thereby enabling the installation of splice holders 402 having a width (W) that may span beyond the distance defined between channels 222, as well as a general increase in flexibility in positioning of the splice holder 402. For example, in some embodiments, the splice holder 402 can be positioned within the interior 226 in a manner that enables improved stowage and retention of fibers or cables routed within the interior 226.

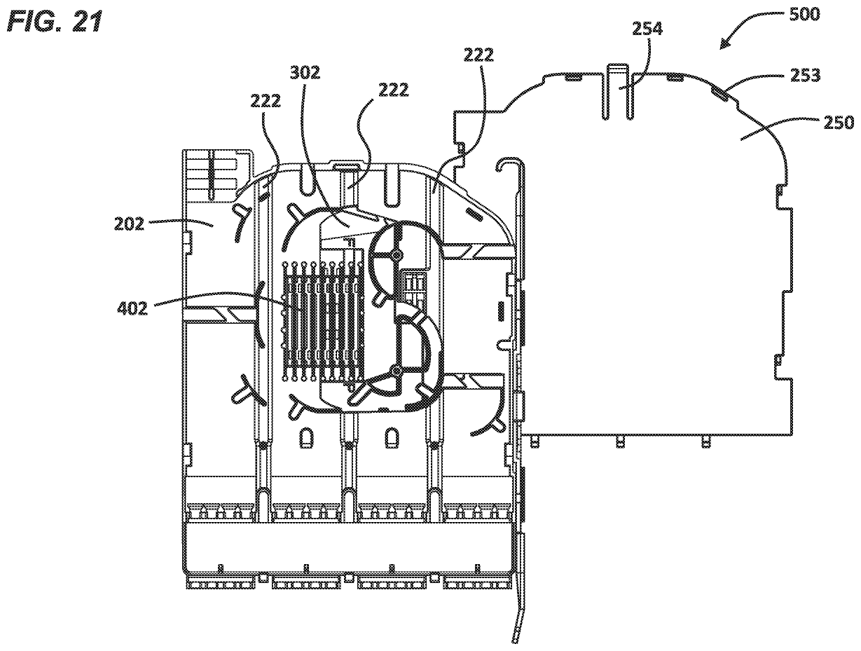

Referring to FIGS. 20-22, various configurations of cassette assemblies 500 are depicted in accordance with embodiments of the disclosure. In some embodiments, the cassette assembly 500 can span the distance between four rails 150 of a tray arrangement 110 (as depicted in FIG. 20). In some embodiments, the cassette assembly 500 can span the distance between six rails 150 of a tray arrangement 110 (as depicted in FIG. 21) in some embodiments, the cassette assembly 500 can span the distance between seven rails 150 of a tray arrangement 110. These disclosed variants are merely representative examples of proposed embodiments, and should not be considered limiting. It is envisioned that the cassette assemblies 500 can assume any shape or size as necessary to generally increase use and density of fiber optic transmission equipment.

Referring to FIG. 23, a method 600 of routing fibers or cables within a cassette assembly is depicted in accordance with an embodiment of the disclosure. The following description and figures detail various steps and procedures which can be included in the method 600, although it should be understood that the individual steps used in the methods of the present teachings may be performed in any order and/or simultaneously, as long as the teaching remains operable. Furthermore, it should be understood that the apparatus and methods of the present teachings can include any number, or all of the described embodiments, as long as the teaching remains operable.

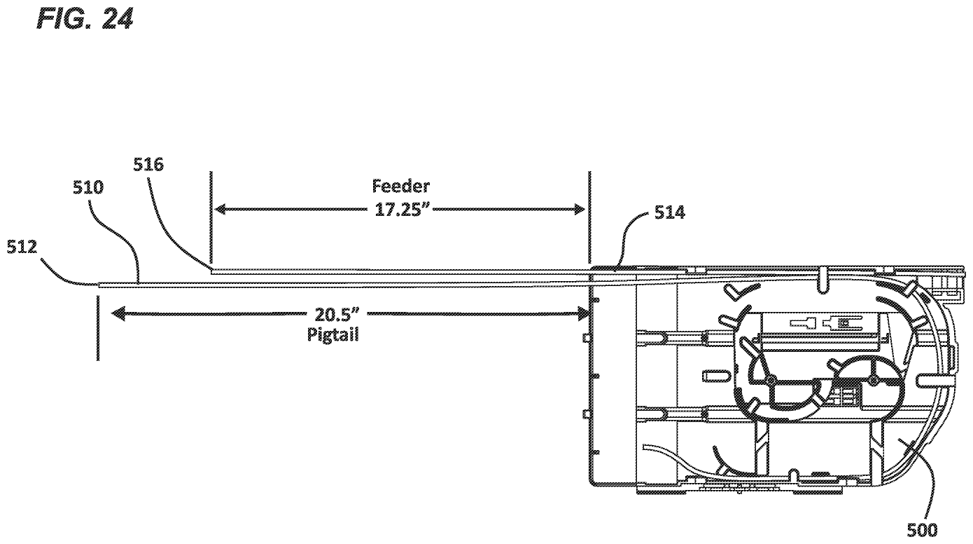

In some embodiments, the method 600 can involve the steps 602, 604, which respectively involve cutting a first fiber or cable, occasionally referred to herein as a “pigtail” to a first predetermined length, and cutting a second fiber or cable, occasionally referred to herein as a “feeder” to a second predetermined length. For example, with additional reference to FIGS. 24-26, depending upon the configuration of the cassette assembly 500, a proximal portion 512 of the first fiber or cable 510 can be cut to a first predetermined length. For example, in some embodiments, a length of the first fiber or cable 510 between a front end 204 of the cassette base 202 and the proximal portion 512 can be cut to a length of 20.5 inches (as depicted in FIGS. 24 & 26) or 22.25 inches (as depicted in FIG. 25); although cutting the first fiber or cable 510 to other lengths is also contemplated.

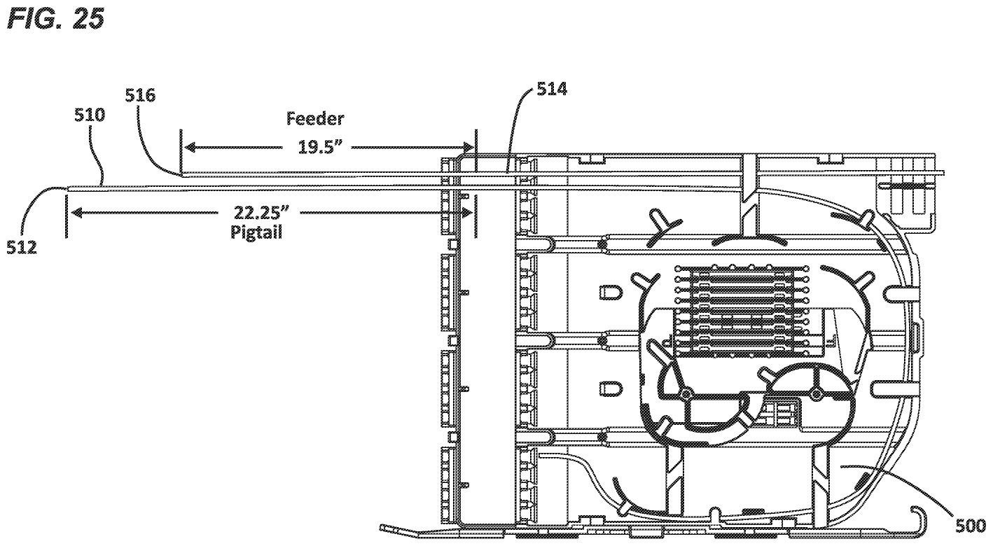

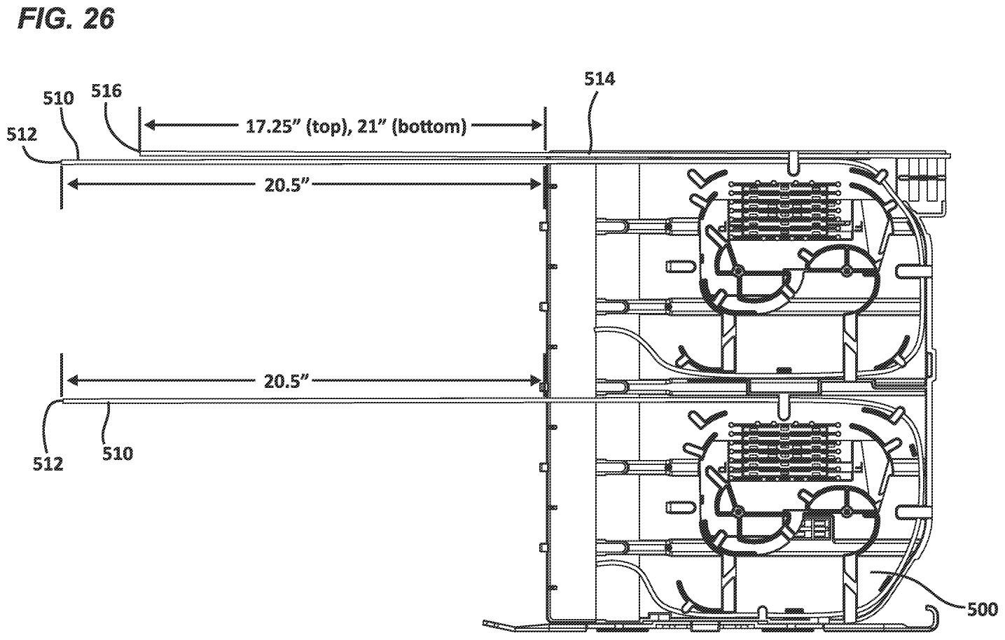

Additionally, depending upon the configuration of the cassette assembly 500, a distal portion 516 of the second fiber or cable 514 can be cut to a second predetermined length. For example, in some embodiments, a length of the second fiber or cable 514 between a front end 204 of the cassette base 202 and the distal portion 516 can be cut to a length of 17.25 inches (as depicted in FIGS. 24 & 26), 19.5 inches (as depicted in FIG. 26), and 21 inches (as depicted in FIG. 26); although cutting the second fiber or cable 514 to other lengths is also contemplated.

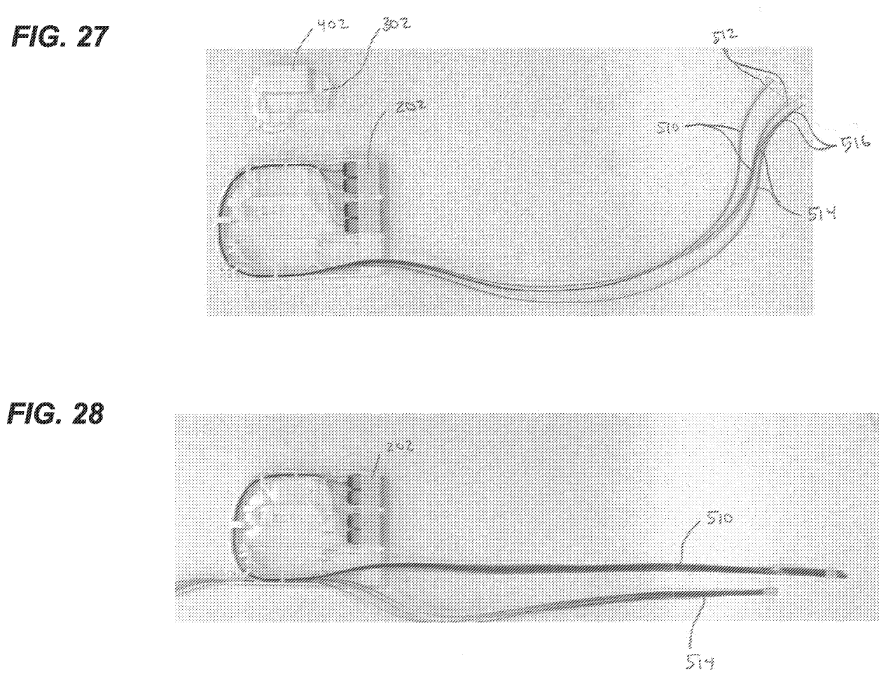

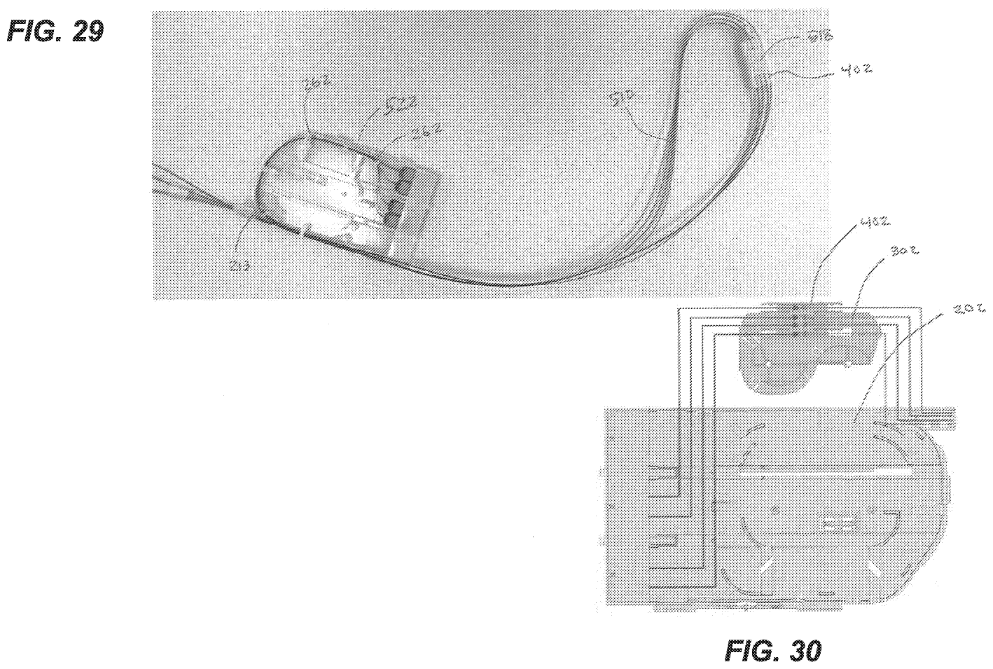

As further depicted in FIGS. 27-28, at step 606, the proximal portion 512 of the first fiber or cable 510 can be spliced to the distal portion 516 of the second fiber cable 514, through one or more splicing techniques generally known in the art. In some embodiments, a splice protector 518 can be positioned at or around the formed splice during the splicing technique. As depicted in FIGS. 29-30, at step 608 the splice protector 518 can be positioned in the splice holder 402.

With continued reference to FIG. 29, at step 610, a distal portion 522 of the first fiber or cable 510 can be routed from a front end 204 of the cassette base 202 past at least one outer loop retention member 262 to a cable entrance 213 positioned at a rear and 206 of the cassette base 202. As depicted, in some embodiments, routing the first fiber or cable 510 in this manner has the effect of axially aligning a portion of the first fiber or cable 510 with the second fiber or cable 514. Specifically, although the fibers or cables may not be axially aligned in the sense of signals passing through the cables (e.g., the fibers or cables may be oriented 180°opposite to one another), the routing in this manner enables the first fiber or cable 510 to be positioned on an inside radius of the second fiber or cable 514, thereby reducing or avoiding the need to cross the first fiber or cable 510 over the second fiber or cable 514 in order to properly stow the excess cable within the interior 226 of the cassette assembly 500.

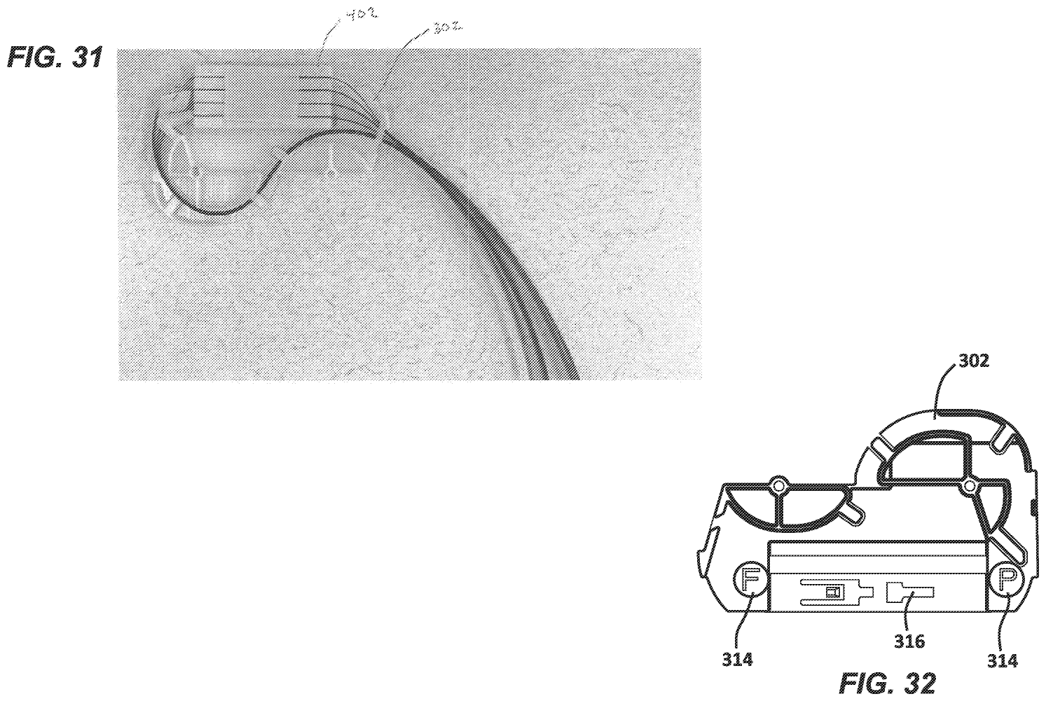

With additional reference to FIGS. 31-32, at step 612, the splice holder 402 can be positioned within the spool 302. For example, in some embodiments, either of the splice holder 402 and/or spool 302 can define a T-shaped aperture 316 and a deflectable latch finger 318 arrangement configured to aid in coupling of the splice holder 402 to the spool 302. Other latching and/or interference couplings are also contemplated. In some embodiments, one or more markings 314 present on either or both of the splice holder 402 or spool 302 can aid in proper orientation of the splice holder 402 relative to the spool 302, as well as in proper orientation of the spool 302 relative to the cassette base 202.

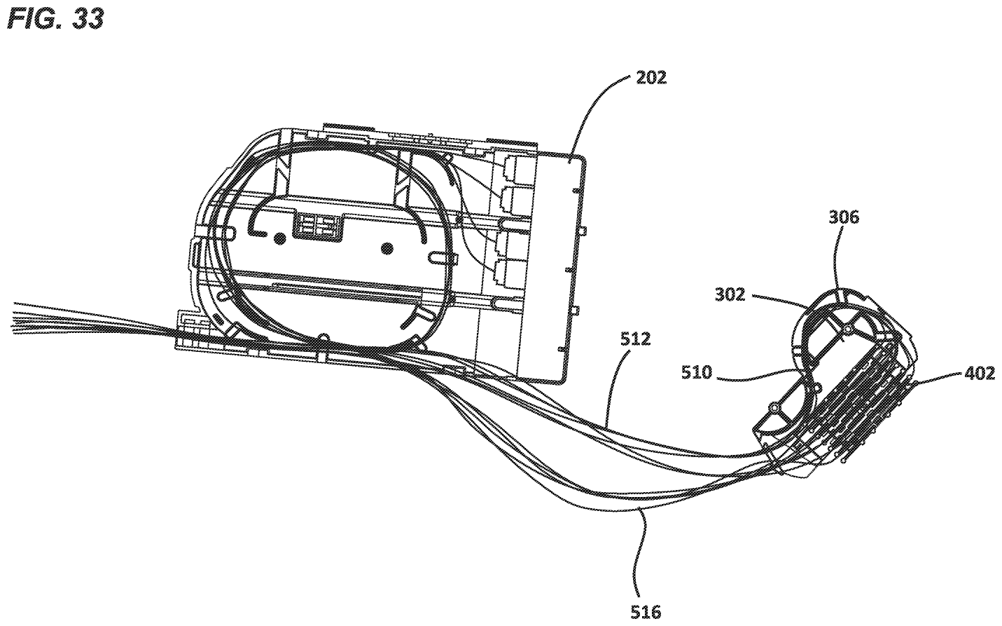

With additional reference to FIGS. 33-36, at step 614, a portion of the first fiber or cable 510 (e.g., proximal portion 512) can be routed through the S-shaped structure 306 defined by the spool 302. In some embodiments, routing the first fiber or cable 510 through the S-shaped structure 306 has the effect of reversing the direction of the first fiber or cable 510, thereby axially aligning the proximal portion 512 of the first fiber or cable 510 with the distal portion 516 of the second fiber or cable 514.

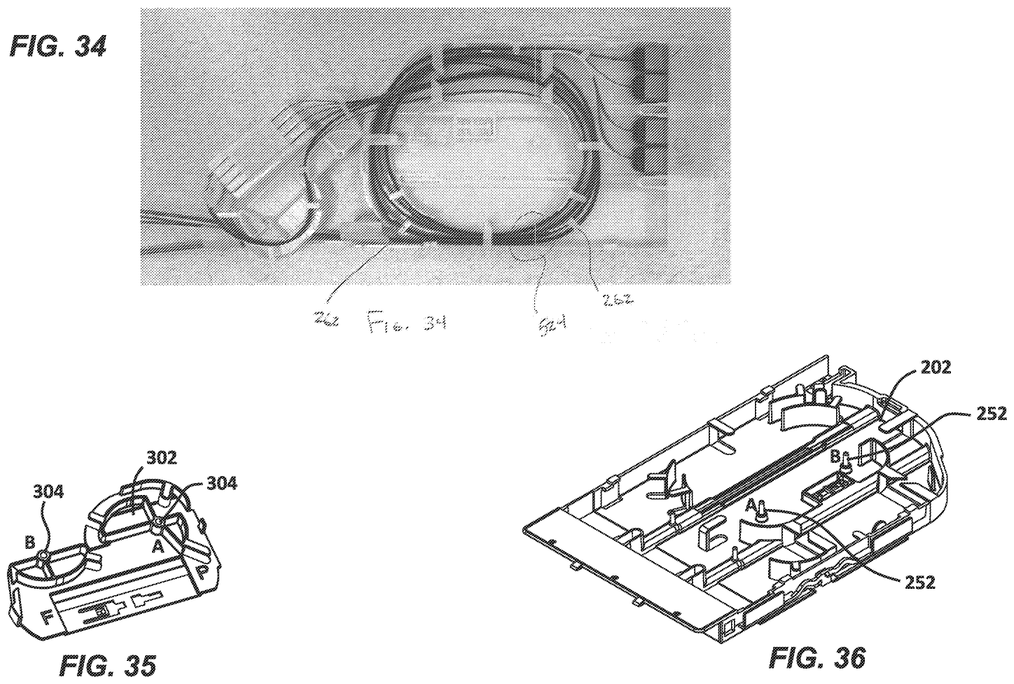

With continued reference to FIGS. 33-34, at step 616, the aligned intermediate portions 524 of the first fiber or cable 510 and the second fiber or cable 514, can be routed past at least one outer loop retention member 262 to form a first, outer loop, and passed at least one inner loop retention member 264 to form a second, inner loop, positioned on an inside radius of the first, outer loop.

With reference to FIGS. 35-36, at step 618, the spool 302 can be positioned within the cassette base 202. For example, in some embodiments, one or more posts 252 defined by either of the cassette base 202 or spool 302, can be received within one or more receptacles 304 defined by either of the cassette base 202 or spool 302. As depicted, the one or more posts 252 are defined by the cassette base 202 and the one or more receptacles 304 defined by the spool 302, although the configuration be reversed to establish a friction based, interference fit between the cassette base 202 and the school 302.

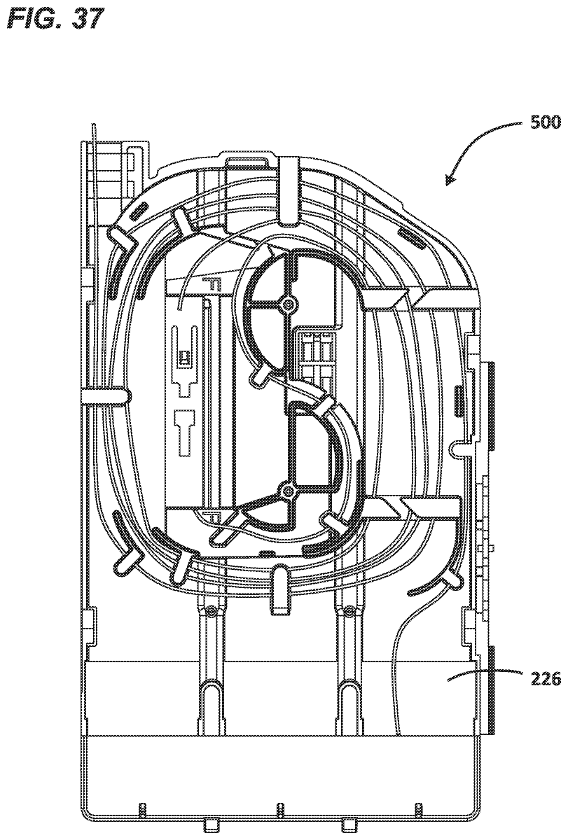

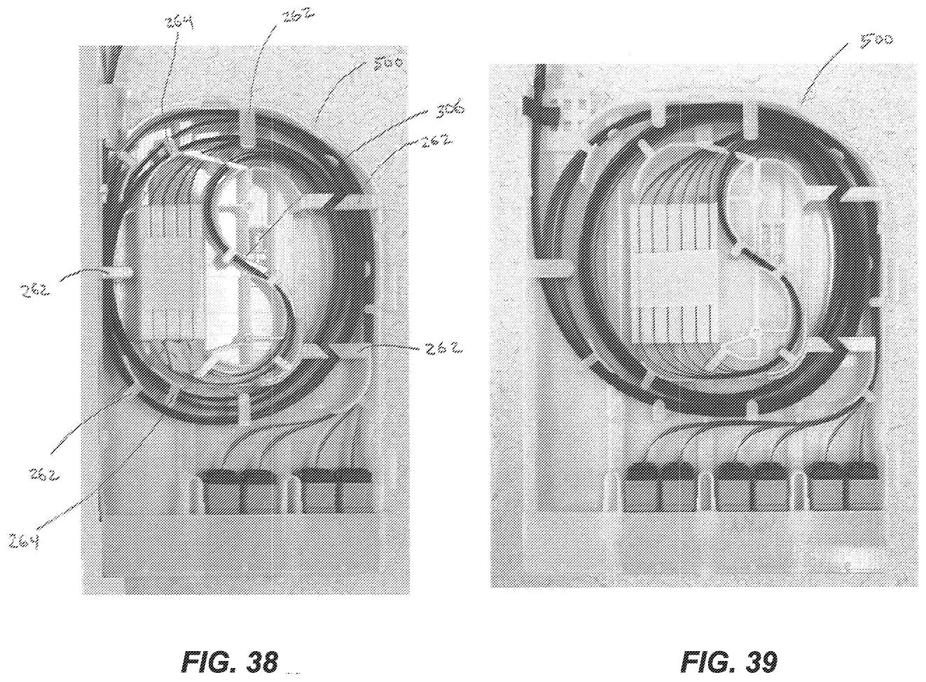

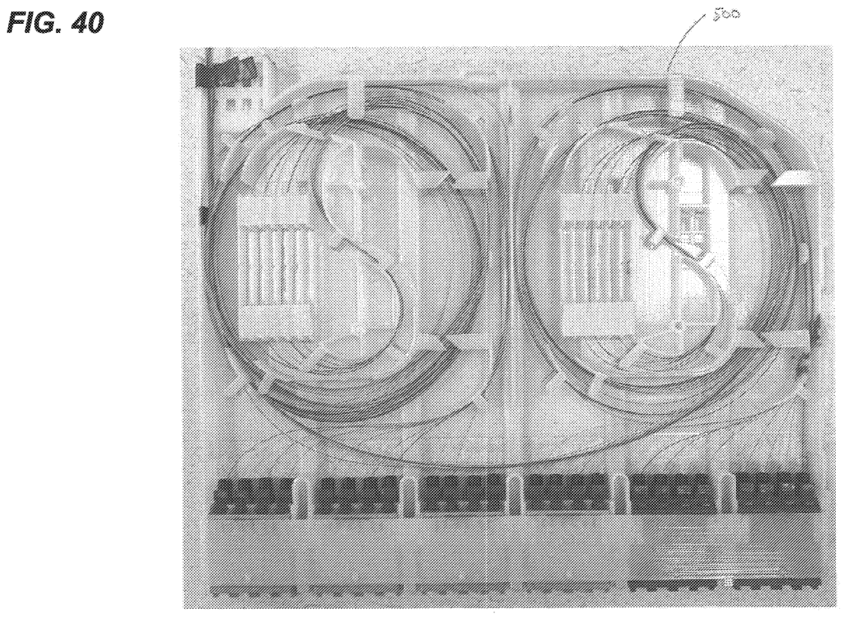

FIG. 37 depicts a schematic view of a routing of fibers or cables within an example cassette assembly 500. As depicted, none of the fibers or cables cross over one another, which presents a significant space savings within the interior 226 of the cassette assembly 500. This is particularly true where the fibers or cables are in the form of ribbons, which are best stored in a coiled configuration (such as that depicted in FIGS. 38-40. Thereafter the cover 250 can be attached to the cassette base 202. In embodiments, the cover 250 can define one or more tabs 253, and a latch member 254 configured to engage with portions of the cassette base 202, thereby enabling the cover 250 to be selectively coupleable and uncoupleable from the cassette base 202.

Having described the preferred aspects and implementations of the present disclosure, modifications and equivalents of the disclosed concepts may readily occur to one skilled in the art. However, it is intended that such modifications and equivalents be included within the scope of the claims which are appended hereto.

1. A cassette assembly adapted to be mounted to a rail of a tray arrangement, the cassette assembly comprising:
a cassette base defining a channel extending at least partially along a length of the cassette base, the channel positioned at an intermediate width between a first side and a second side of the cassette and sized to receive the rail of the tray arrangement to enable the cassette base to extend over the rail of the tray arrangement, the channel defining a splice holder receiving channel having the effect of exposing a top surface of the rail of the tray arrangement to an interior of the cassette base;
a spool selectively coupleable to the cassette base, the spool defining one or more fiber management members to facilitate routing fibers or cables within the interior of the cassette base;
a splice holder selectively coupleable to the spool and positionable within the splice holder receiving channel defined by the cassette base, wherein a bottom surface of the splice holder is positioned adjacent to and faces a top of the rail of the tray arrangement, enabling the splice holder to be positioned above the rail of the tray arrangement.

2. The cassette assembly of claim 1, further comprising a cover selectively coupleable to the cassette base to at least partially enclose the interior of the cassette base.

3. The cassette assembly of claim 1, wherein the splice holder is selectively secured to the spool by a T-shaped aperture and a deflectable latch finger arrangement.

4. The cassette assembly of claim 1, wherein the cassette base defines one or more posts configured to be received in one or more receptacles defined by the spool to selectively secure the spool to the cassette base by an interference fit connection.

5. The cassette assembly of claim 1, wherein the cassette base defines a plurality of port member receiving apertures at a front of the cassette base.

6. The cassette assembly of claim 5, wherein the cassette base defines at least one of three port member receiving apertures, four port member receiving apertures or six port member receiving apertures at a front of the cassette base.

7. The cassette assembly of claim 5, wherein the cassette base defines structure configured to enable routing of a first fiber or cable from one of the plurality of port member receiving apertures at the front of the cassette base to a region of the cassette base configured to receive a splice holder.

8. The cassette assembly of claim 7, wherein the cassette base defines at least one outer loop retention member configured to receive a first, outer loop of the first fiber or cable, and at least one inner loop retention member configured to receive a second, inner loop of the first fiber or cable as the first fiber or cable traverses from one of the plurality of port member receiving apertures at the front of the cassette base to the region of the cassette base configured to receive a splice holder.

9. The cassette assembly of claim 8, wherein the spool defines an S-shaped structure configured to enable routing of the first fiber or cable from one of the plurality of port member receiving apertures at the front of the cassette base to the region of the cassette base configured to receive a splice holder.

10. The cassette assembly of claim 1, wherein the cassette base defines a cable entrance at a rear of the cassette base.

11. The cassette assembly of claim 10, wherein the cassette base defines structure configured to enable routing of a second fiber or cable from the cable entrance at the rear of the cassette base to a region of the cassette base configured to receive a splice holder.

12. A cassette assembly, comprising:
a cassette base adapted to be mounted to a rail of a tray arrangement, the cassette base defining a port member receiving aperture at a front of the cassette base, a cable entrance at a rear of the cassette base, and a region of the cassette base configured to receive a splice holder, wherein the cassette base defines one or more first structures configured to enable routing of a first fiber or cable from the port member receiving aperture at the front of the cassette base to the region of the cassette base configured to receive a splice holder, and one or more second structures to enable routing of a second fiber or cable from the cable entrance at the rear of the cassette base to the region of the cassette base configured to receive a splice holder; and
a spool coupleable to the cassette base defining an S-shaped structure configured to enable routing of the first fiber or cable from the port member receiving aperture at the front of the cassette base to the region of the cassette base configured to receive a splice holder.

13. The cassette assembly of claim 12, wherein the cassette base defines at least one of three port member receiving apertures, four port member receiving apertures or six port member receiving apertures at a front of the cassette base.

14. The cassette assembly of claim 12, wherein the cassette base defines at least one outer loop retention member configured to receive a first, outer loop of the first fiber or cable, and at least one inner loop retention member configured to receive a second, inner loop of the first fiber or cable as the first fiber or cable traverses from the port member receiving aperture at the front of the cassette base to the region of the cassette base configured to receive a splice holder.

15. The cassette assembly of claim 12, wherein the cassette base defines at least one outer loop retention member configured to receive a first, outer loop of the second fiber or cable, and at least one inner loop retention member configured to receive a second, inner loop of the second fiber or cable as the second fiber or cable traverses from the cable entrance at the rear of the cassette to the region of the cassette base configured to receive a splice holder.

16. The cassette assembly of claim 12, further comprising a splice holder selectively coupleable to the spool and positionable within a splice holder receiving channel defined by the cassette base, wherein a bottom surface of the splice holder is positioned adjacent to and faces a top of the rail of the tray arrangement, enabling the splice holder to be positioned directly above the rail of the tray arrangement.

17. The cassette assembly of claim 12, wherein the splice holder is selectively secured to the spool by a T-shaped aperture and a deflectable latch finger arrangement.

18. The cassette assembly of claim 12, wherein the cassette base defines one or more posts configured to be received in one or more receptacles defined by the spool to selectively secure the spool to the cassette base by an interference fit connection.

19. The cassette assembly of claim 12, further comprising a cover selectively coupleable to the cassette base to at least partially enclose an interior of the cassette base.

20-24. (canceled)

25. A cable and cassette assembly, comprising:
a cassette base adapted to be mounted to a rail of a tray arrangement, the cassette base defining a port member receiving aperture at a front of the cassette base, a cable entrance at a rear of the cassette base, and a region of the cassette base configured to receive a spool, wherein the cassette base defines one or more first structures configured to enable routing of a first fiber or cable from the port member receiving aperture at the front of the cassette base to the region of the cassette base configured to receive a spool, and one or more second structures to enable routing of a second fiber or cable from the cable entrance at the rear of the cassette base to the region of the cassette base configured to receive a spool; and
a spool coupled to the cassette base defining an S-shaped structure configured to enable routing of the first fiber or cable from the port member receiving aperture at the front of the cassette base to the region of the cassette base configured to receive the spool;
a splice holder coupled to the spool on a top surface of the spool;
wherein at least a portion of a bottom surface of the spool is positioned above the rail of the tray arrangement.

26-27. (canceled)
